(19) United States
(12) Patent Application Publication
(10) Pub. No.: US 2011/0200728 A1
(43) Pub. Date: Aug. 18, 2011

(54) Foil pie rings

(76) Inventor: Lois Ann Brown, Sun City, CA (US)

(21) Appl. No.: 12/930,197

(22) Filed: Dec. 31, 2010

Related U.S. Application Data
(60) Provisional application No. 61/335,080, filed on Dec. 31, 2009.

(51) Int. Cl. A21B 3/13; A21D 8/06

(52) U.S. Cl. 426/465; 99/645

(57) ABSTRACT

The present invention provides coverings formed into a pie shape, to shield the outer crust of a pie during baking. The ring-like design features an open center area, which leaves the top portion of the pie exposed during the baking process comprising a ring having aluminum coverage area approximately one quarter inch in width, sufficient to completely shield the outer crust area. This invention is offered in a variety of sizes to accommodate virtually any pie size, from smaller pot pies that measure around six inches up to and even exceeding a total diameter of approximately twelve inches which are standard for most fruit pies.

### CLAIM OF PRIORITY

This patent application claims priority under 35 USC 119(e) (1) from U.S. Provisional Patent Application Ser. No. 61/335,080 filed Dec. 31, 2009, of common inventorship herewith entitled, “Foil Pie Rings.”

### FIELD OF THE INVENTION

The present invention pertains to the field of baking devices, and more specifically to the field of pie crust protectors.

### BACKGROUND OF THE INVENTION

The prior art has put forth several designs for pie crust protectors. Among these are:

U.S. Pat. No. 3,951,053 to Margaret A. Kirkpatrick describes a pie crust lip protector device composed of a heat reflecting material for protecting the lip of the crust of a pie from burning during baking.

U.S. Pat. No. 5,456,162 to Joseph Polizzotto describes a pie crust baking shield for protecting the outer edge portion of pie crust while a pie is being baked. The device may be provided either pre-formed into a ring with unconnected ends or straight for packaging purposes. Both embodiments are flexibly deformable to fit around a range of pie crust diameters and include an upright continuous flange portion and a plurality of side by side generally horizontal flange segments extending orthogonally from the upright flange portion. The free ends of the shield are releasably connectable in overlapping fashion against one another to define a plurality of pre-selected pie diameters. In use, the horizontal flange segments are supported atop the pie crust edge to define a continuous shield thereover which prevents burning the edge of the pie during baking.

U.S. Pat. application Design D384,550 to Margo Dernoga illustrates an ornamental design for a cover for pie crust edge.

None of these prior art references describe the present invention.

### SUMMARY OF THE INVENTION

It is an object of the present invention to provide a protective pie crust ring to prevent burning of the exposed crust.

### BRIEF DESCRIPTION OF THE DRAWINGS

FIG. 1 is an elevational angled perspective view of the device of the present invention in place on a pie.

FIG. 2 is an elevational angled perspective view of the device of the present invention suspended above a pie.

FIG. 3 shows an elevational angled perspective view of the device of the present invention in several embodiments of various sizes.

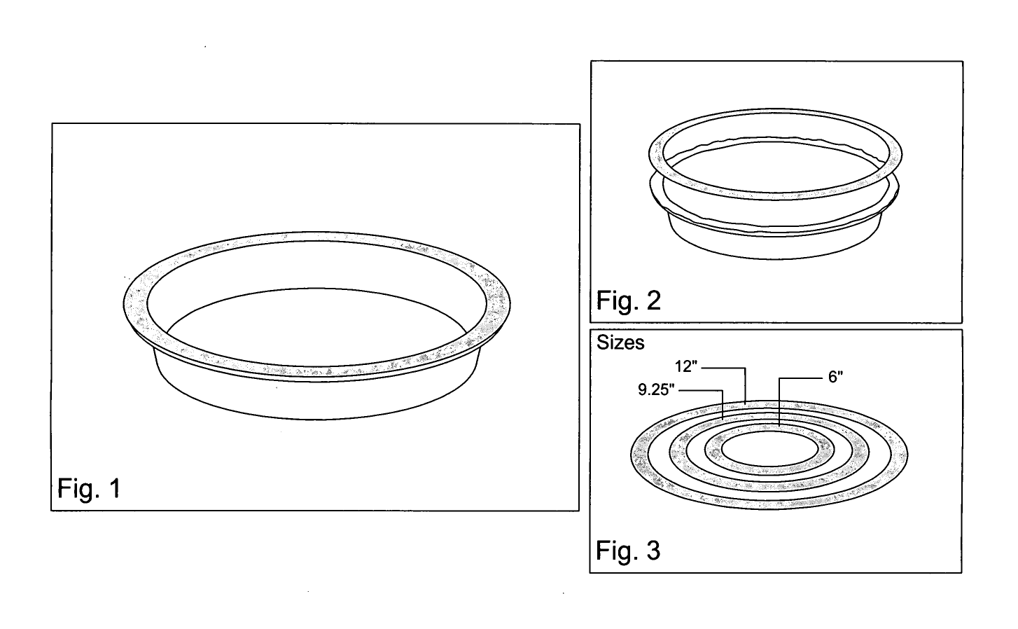

### DETAILED DESCRIPTION OF THE INVENTION

A pie is a baked dish, with a baked shell usually made of pastry that covers or completely contains a filling of meat, fish, vegetables, fruit, cheeses, creams, chocolate, custards, nuts, or other sweet and savory ingredients. Pies can be either “one-crust,” where the filling is placed in a dish and covered with a pastry/potato mash top before baking, or “two-crust,” with the filling completely enclosed in the pastry shell. Some pies have only a bottom crust, generally if they have a sweet filling that does not require cooking. These bottom-crust-only pies are known as tarts or tartlets. One example of a savory bottom-crust-only pie is a quiche. Tarte Tatin is a one-crust fruit pie that is served upside-down, with the crust underneath. Yet, the two-crust pies are perhaps the most universally common, from the piping-hot slices of apple pie serving as the foundation for a sweet scoop of vanilla ice cream to “pot pies” filled to bursting with succulent meats and vegetables that stand alone as a complete meal. Whether one purchases pre-made, frozen pies that are ready to eat in half an hour or enjoys the meticulous preparation of pies from scratch, careful attention must be paid to the pie as it heats in the oven. Particularly, the “hills and valleys” of a pie's outer crust edge are more susceptible to burning than the surface of the pie. To prevent this, pie preparers employ strips of aluminum foil, wrapping the tender crust edge in a protective shield. While effective, this method can be a bit time consuming, as one must properly measure the foil and utilize several strips of various sizes before optimal crust coverage is achieved.

The present invention, hereinafter referred as the Foil Pie Rings, is a practical product invention that offers a convenient solution to the aforementioned challenge. Simply stated, this product is a line of aluminum coverings that are already formed into a pie shape, allowing users to effectively shield the outer crust of a pie in one fell swoop. Basically circular in shape, each Foil Pie Ring's aluminum coverage area is approximately one quarter inch in width, sufficient to completely shield the outer crust area. Thus, this ring-like design features an open center area, which leaves the top portion of the pie exposed during the baking process. This product is offered in a variety of sizes to accommodate virtually any pie size, from smaller pot pies that measure around six inches up to and even exceeding a total diameter of approximately twelve inches which are standard for most fruit pies. The Foil Pie Rings are packaged in bulk with up to six units of various sizes provided in each box. In addition, pre-made pies are packaged with one or two Foil Pie Rings in each box.

Use and application of the Foil Pie Rings is very simple and straightforward. First, the user selects the appropriately sized Foil Pie Ring to accommodate the pie being prepared. To apply the Foil Pie Rings, the user simply places the foil over the top of the pie, so that the outer crust is completely covered. Next, using the fingers as a guide, the outer edges of the foil are folded under the pie pan to secure the Foil Pie Ring. In this manner, the unit serves as a protective barrier between the heat of the oven and the outer crust during the baking process, while leaving the remaining portions of the pie properly exposed. After the pie is finished baking and cooled, the user simply separates the foil from the pan and discards it in the closest garbage receptacle. What is left behind is a perfectly cooked pie with a tastefully browned, flaky outer crust.

There are several significant benefits and advantages associated with this unique product invention. Foremost, the Foil Pie Rings provide consumers with a simple, effective means of keeping an outer pie crust from burning during preparation. Cleverly designed aluminum foil that is specially configured for just this purpose, this practical product offers a handy, instant shield for this tender area of the pie. In this manner, Foil Pie Rings are applied to and removed from virtually any pie in a matter of seconds, eliminating the need to meticulously measure multiple foil strips before placing the pie into an oven. As a result, pies that serve as meals or desserts are instantly ready to bake, cutting down on food preparation times in today's busy and fast-paced world. Separately packaged for scratch-made pies or conveniently offered with frozen varieties, the Foil Pie Rings appeal to seasoned and novice pie makers alike. While this product is primarily conceived with household users in mind, restaurants and bakeries find the time-saving Foil Pie Rings ideal for use in their daily operations.

An innovative product invention, the Foil Pie Rings readily enhance the practice of preparing pies in an oven. Lightweight and disposable, this accessory proves an invaluable addition to any kitchen.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A protective pie crust ring to prevent burning of the exposed crust, comprising circular rings to shield the outer crust of a pie during baking; wherein the coverage area is approximately one quarter inch in width and circumscribes the pie; further comprising an open center area, to allow the top portion of the pie to be exposed during the baking process.

2. The protective pie crust ring of claim 1 comprising aluminum.

3. The protective pie crust ring of claim 1 wherein the diameter of the open center area is between approximately six inches and twelve inches.

4. The protective pie crust ring of claim 1 wherein the diameter of the open center area is less than approximately six inches.

5. The protective pie crust ring of claim 1 wherein the diameter of the open center area is greater than approximately twelve inches.

6. A method of preventing burning of a pie crust during baking comprising placing the unbaked pie in a protective foil pie ring; wherein the protective foil pie ring comprises a circular ring to shield the outer crust of a pie during baking; wherein the coverage area is approximately one quarter inch in width and circumscribes the pie; further comprising an open center area, to allow the top portion of the pie to be exposed during the baking process.
